(19) United States
(12) Patent Application Publication
(10) Pub. No.: US 2005/0219844 A1
(43) Pub. Date: Oct. 6, 2005

(54) Birdhouse

(76) Inventors: Nancy J. Hoffman, Green Bay, WI (US); Ronald W. Hoffman, Green Bay, WI (US)

Correspondence Address: Philip M. Weiss;Weiss & Weiss, Suite 201, 310 Old Country Road, Garden City, NY, 11530, US

(21) Appl. No.: 10/812,769

(22) Filed: Mar. 30, 2004

(51) Int. Cl. F21V 33/00

(52) U.S. Cl. 362/253; 362/806

(57) ABSTRACT

A block light birdhouse, comprising a roof on top of a clear block fixture, and a light source placed inside the clear block fixture

### FIELD OF THE INVENTION

The present invention relates to a block light birdhouse.

### BACKGROUND OF THE INVENTION

U.S. Pat. No. 4,951,181 relates to a light diffusing glass block furniture. It includes a generally planar platform portion and a base portion for supporting the platform portion. The base portion includes a plurality of interengaged glass blocks and a frame for enclosing the glass blocks. A light source is disposed in the base portion for providing illumination in the glass blocks.

U.S. Pat. No. 5,006,967 relates to self illuminating glass block construction unit having an electrical assembly intragally attached through a glass wall of the unit, thereby allowing the unit to be self illuminated.

### SUMMARY OF THE INVENTION

The present invention relates to a block light birdhouse. The birdhouse comprises a roof on top of a block fixture. A light source is placed through the back of the block to light up the birdhouse. It is an object of the present invention for the roof to be shaped like a gambrel, gull wing, gable, shed, or salt box style. It is an object of the present invention for the block to be made from glass, acrylic or plastic. It is an object of the present invention for the block to be in the shape of a square or rectangle.

It is an object of the present invention for artificial floral accents such as trees or bushes to be attached to the bottom of the platform. It is an object of the present invention for the figure of an animal such as a bird, owl, or butterfly to be placed on a perch in the block or on top of the roof.

It is an object of the present invention for the roof to be made of wood. It is an object of the present invention for the roof to be painted, stained or be natural. It is an object of the present invention for the lights that are placed inside the block to be clear or colored lights.

### BRIEF DESCRIPTION OF THE DRAWINGS

FIG. 1 is a front view of the birdhouse;

FIG. 2 is a back view of the birdhouse.

### DETAILED DESCRIPTION OF THE INVENTION

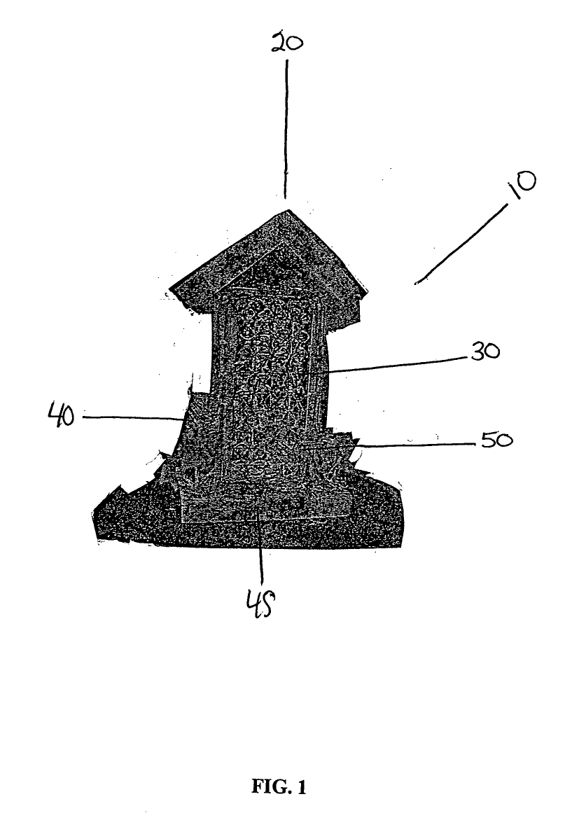

FIG. 1 illustrates a front view of a birdhouse 10. The birdhouse 10 is comprised of a roof 20 which can be shaped like a gambrel, gull wing, gable, shed or salt box. The roof 20 rests on a block 30 which can be made of glass, acrylic or plastic and can be made of a square or rectangular shape. Around the block 30 is shown artificial floral accents 40 which are attached to the bottom platform 45. An animal such as a bird, owl or butterfly can be placed on a perch 50 which can be placed top of the platform 45 as shown or on top of the roof 20.

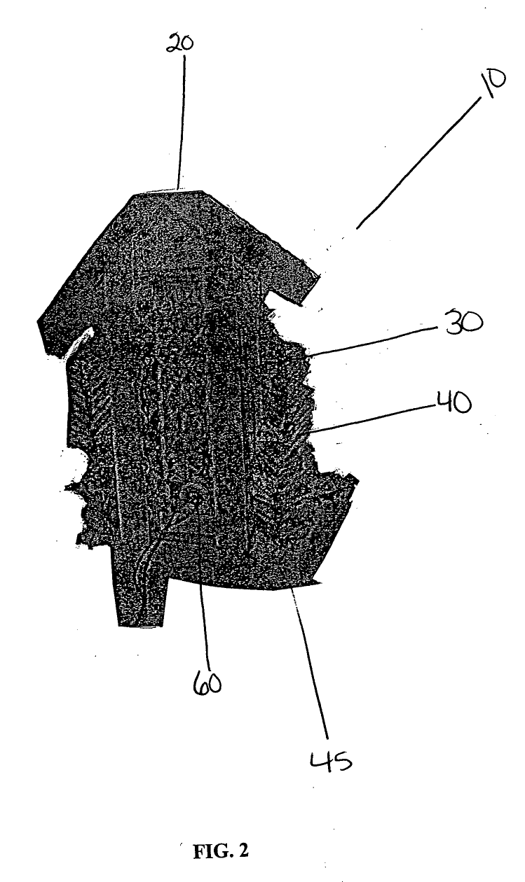

FIG. 2 illustrates a back view of a birdhouse 10. The birdhouse 10 shows a roof 20 which can be made out of wood. The roof 20 can be painted, stained or natural color. A light or group of lights 60 is placed inside the block through a hole in the block in the back of the birdhouse 10. The lights 50 can be clear or colored.

1. A block light birdhouse comprising:
a roof on top of a clear block fixture;
a light source placed inside said clear block fixture

2. The birdhouse of claim 1 wherein said light source is placed in said block fixture through the back of said fixture.

3. The birdhouse of claim 1 wherein said roof is shaped like a gambrel, gull wing, gable, shed, or salt box style.

4. The birdhouse of claim 1 wherein said block is made from glass, acrylic or plastic.

5. The birdhouse of claim 1 wherein said block is in the shape of a square or rectangle.

6. The birdhouse of claim 1 further comprising
artificial floral accents such as trees or bushes attached to a platform.

7. The birdhouse of claim 1 further comprising:
a figure of a bird, owl, or butterfly to be placed on a perch in said block or on top of said roof.

8. The birdhouse of claim 1 wherein said roof is made of wood.

9. The birdhouse of claim 1 wherein said roof is painted or stained.

10. The birdhouse of claim 1 wherein said light source comprises clear or colored lights.
